(19) United States
(12) Patent Application Publication
(10) Pub. No.: US 2002/0087286 A1
(43) Pub. Date: Jul. 4, 2002

(54) Method for generation of electronic reports

(76) Inventor: Bradley W. Mitchell, Eagle Mountain, UT (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/752,201

(22) Filed: Dec. 30, 2000

(51) Int. Cl. G01D 1/00

(52) U.S. Cl. 702/127

(57) ABSTRACT

Numerous embodiments for a method for generation of electronic reports are disclosed.

### BACKGROUND

1. Field

This disclosure relates to electronic data mining, data compiling, and/or data reporting, and more particularly, to collecting data, manipulating data, and selectively reporting some form of the data based at least in part on a priority or statistical system.

2. Background Information

The evolution of the Internet has created a large influx of available data regarding web site usage statistics, elapsed time to complete electronic requests, transactional information, and many other types of information relating to online activity. A need exists for techniques to collect and report online data, for multiple uses that may include, for example, web site improvements, evaluating efficiencies, or any number of other purposes.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic diagram representing one embodiment of a data compiler in accordance with the present invention.

FIG. 2 is a flowchart representing one embodiment for a method for generation of electronic reports in accordance with the present invention.

FIG. 3 is a block diagram illustrating a processing system in accordance with one embodiment of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An area of current technological development relates to online analytical processing of data, commonly known as OLAP. This area of technological development may also be known as electronic data mining, data gathering, data reduction, and/or reporting of collected electronic data. The purposes for reporting electronic data are varied, but may be for assessing web site efficiencies or usage, analyzing online business transactions, or for a variety of other reasons. In this context, “data” may comprise data regarding any online event or electronic transaction, which may be as diverse as the number of web site “hits” in a given period of time, typical user responses within a web page, the time to complete an electronic transaction such as via one or a series of related http requests, the number of occurrences of a text value, such as a name of a computer, a user, or a URL (uniform resource locators) on a web site, or even Boolean values that may represent occurrences of certain electronic transactions, such as user responses to an online survey, for example. In this context, electronic data may also include numerical representations of data. However, there are, of course, many different types and categories of data that may be collected and reported, and the invention is not limited in scope to a particular type of category. Depending on the particular situation, some data types may be more desirable than others, however, all such types are included within the scope of the invention. Additionally, it may be desirable to report data if there has been a change in a value such as, for example, a change in web site hits, or completion time of an electronic transaction. There may also be a desire, depending upon the circumstances, to adjust the quality or frequency of data reports. A system that allows the user to adjust delivery of one or more reports, based at least in part on values representing the importance of a report, and/or its relevance, may be desirable. Such an approach may have advantages, such as reducing the issuance of less important reports and freeing up system resources for creating reports that are more desirable to a particular user.

In accordance with one embodiment of the invention, a method for the generation of electronic reports may include gathering electronic data from at least one external source, where the data relates at least partially to online activity. The data collection, in one embodiment, is performed by a data collection agent, which, in this context, refers to any device that is capable of collecting electronic data. In this embodiment, at least a portion of the data may be stored, wherein the storage may be on a resident computing platform, or may be on a computing platform separate or remote from the resident computing platform. In this context, a resident computing platform refers to a computing platform in which a user would access the data collected in accordance with this invention. The data may not be entirely stored, but in an alternative embodiment, a representation of the data may be stored in addition to or in place of the entire data set itself, such as, for example, a numerical value representing a particular type of electronic transaction, or a text value. The data that is stored, when retrieved, may be placed on an electronic scoreboard. Here, the term electronic scoreboard refers to a compilation of one or more data fields, which contain data that is stored in one embodiment of the invention. In this embodiment, the data fields contain a collection of electronic data that is interrelated. In this context, interrelated means that the data shares some of the same qualities or represent the same or similar online events, such as, for example, the elapsed times for various transactions, or relate to various types of activity on a particular web site or set of web sites. In one embodiment, electronic transactions are tracked and records of these electronic transactions may be stored as electronic data. In this context, electronic transactions refer to any sort of activity on a particular web site, or set of associated web sites. In this embodiment, the stored data is then at least partially used to calculate one or more sample statistics or representative values. The sample statistics or representative value or values in one embodiment may comprise the mean and standard deviation. However, a sample statistic or statistical value refers to any type of representative value that could be used to represent a larger set of data, and therefore the invention is not limited to a particular statistical measure, such as mean and/or standard deviation. In this embodiment, when new or additional data is inserted in a data field, the oldest or least relevant data value may be discarded. Of course, this is just one embodiment, and the invention is not limited in this respect. For example, no data values may be discarded, and all data may be retained in a data field, or after a certain number of data points or samples are collected, then a certain number of older or less relevant data may be discarded. When the new or additional data is inserted in the data field, the statistical value or values may then be recalculated. In this embodiment, the statistical value or values, upon calculation or recalculation, may then be compared to a threshold value. In one embodiment, the threshold value comprises a numerical value that at least partially relates to the data values collected. In one embodiment, the threshold value may be used to establish a priority system or derive a priority value for the ranking of electronic reports, as explained in more detail later.

This threshold value may be determined in this embodiment based at least in part on the type and/or quality of data collected. The threshold value may be preset before the method is used, or it may be determined by a user, at any time before, after or during the data collection. This threshold value, in this particular embodiment, comprises a value that is compared to the statistical value or values, to determine if the statistical value or values meets or exceeds the threshold value. In one embodiment, if the threshold value is exceeded, at least a portion of the data contained within a data field is designated for reporting, and a report will be generated comprising at least a portion of the collected data that is associated with the threshold value and statistically based value or values. Of course, alternatively, a similar process may involve at least a portion of data being designated for reporting only if the threshold value is not exceeded. This process comprises one possible embodiment of a priority system in accordance with the present invention. Of course, the invention is not limited in this respect, as explained in more detail later. The threshold value may be configured by a user, either before, after or during the issuance of electronic reports, for reasons including reducing or increasing the frequency of reporting, or altering the amount and quality of a report. Of course, the invention is not limited in this respect, and many other alternatives are also possible, as explained in more detail later. In this context, a data compiler comprises a collection of electronic data that is contained within one or more data fields, and may also be referred to as a data reducer. The data compiler further has the capability to calculate statistical or representative values of the collected electronic data, in accordance with one embodiment of the present invention. Of course, this is just one embodiment, and is not intended to limit the scope of the present invention.

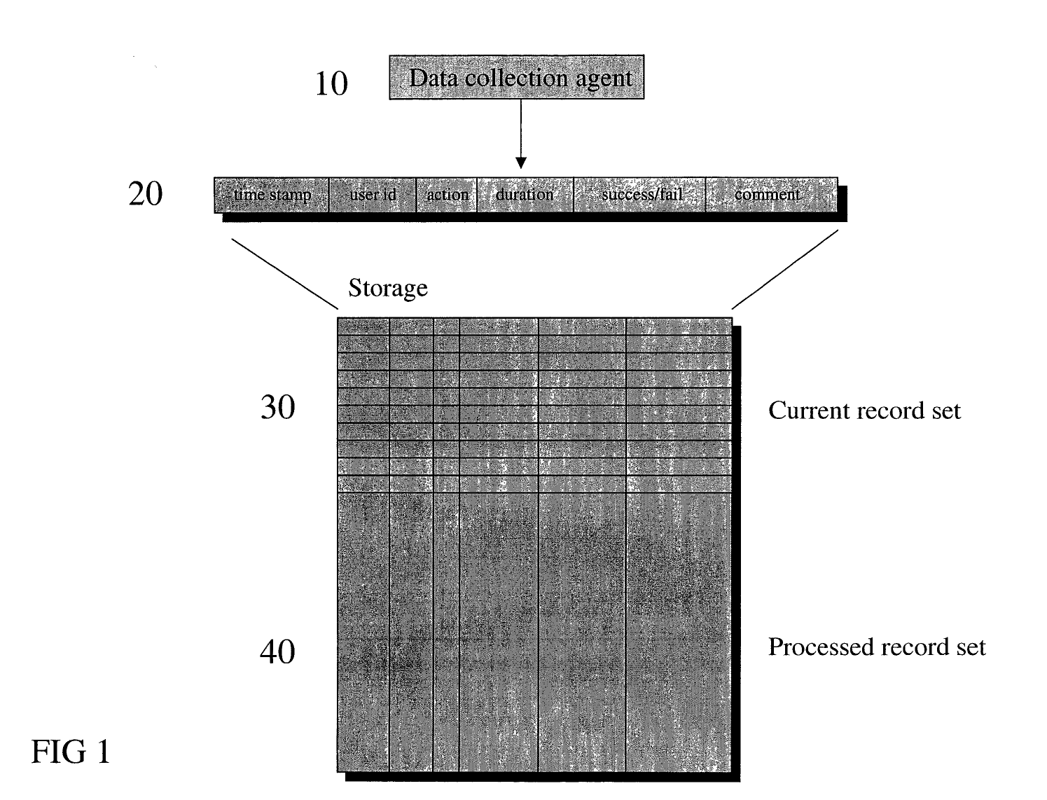

FIG. 1 is a schematic diagram showing a data compiler that represents one embodiment of the present invention. Block 10 depicts a data collection agent that is capable of collecting some form of electronic data that relates to online activity. In this embodiment, the data collection agent may or may not be external to the data compiler, but may execute on the same computing platform, such as in the form of a software application. Likewise, a data collection agent in accordance with the present invention may alternatively reside on a computing platform that is separate or remote from the computing platform that houses the data compiler, and, in this instance, the data collection agent may be networked at least periodically with the computing platform that houses the data compiler. Block 20 depicts an example of data that may be collected by a data collection agent. It is noted that the data is not restricted to the format illustrated. The data collection agent may report any or all of the data at any given reporting time, and the reporting time may be determined by the data collection agent. There are many examples of the type of data that may be collected by a data collection agent, and this embodiment serves as just an example of data that may be collected. Block 30 represents a set of data fields, which comprises a scoreboard of data. At least a portion of the data in 20 is inserted into the data fields shown in 30, where each data field contains data that is at least partially interrelated, or of a similar type of data, such as, for example, elapsed time for a variety of different electronic transactions, to provide just one example. In this embodiment, portion 40 of scoreboard 30 represents processed data, which results from the calculation of statistical values in accordance with one embodiment of the invention. The statistical values may be contained in the same file or physical location as the collected data, or may be stored at some alternate or external locations. Of course, it will be understood that FIG. 1 is only one possible embodiment of the present invention, and the invention is not limited to just this example.

In accordance with one embodiment of the invention, a method of compiling electronic data comprises gathering data from at least one internet or online source. In this context, internet or online source refers to any other device remote from the device that is collecting the electronic data, which, in one embodiment, may be referred to as a data collection agent. This may include, for example, servers or computers coupled by a network. Of course, the invention is not limited in this respect. For example, data may be collected from the same system that is performing the data collection. The data collection agent may or may not be contained on a resident system, and may be customized or be “out of the box” meaning, in this context, that the method of collection is not customized by a user and the software itself is preset in regard to what data is to be collected, and the manner in which it is collected, such as mass-distributed software purchased from a retail outlet, for example. The data collection may or may not be performed by a resident computer system. The system may gather information, such as the number of web site hits, or other online activity, depending upon the type of data collection software, and the configuration of the software. In one embodiment, the data collection is performed by one computer system, while the storing of the data is performed by another computer system that is networked to the data collection system. In another embodiment, the data collection agent may comprise an application specific data collection software program that may be used for an external or non-related purpose, such as, for example, a web log, which comprises a record of web sites that have been accessed from a particular computing platform, or by a particular user. In this embodiment, the method for collecting electronic data includes the ability to store at least a portion of the electronic data, or a representation of the collected data, where the electronic data may be stored on a resident system, or on a system different than the system performing the data collection. Any or all of the data may be stored in this embodiment, depending upon a variety of factors, such as the configuration of the software and the importance of data, for example, which may be preset within the software program or may be determined by a user, for example. The electronic data may be stored at least in part for the purpose of reporting the data out at some future time. Of course, the invention is not limited in this respect, as explained in more detail later.

In this embodiment, the method of compiling electronic data may further comprise gathering electronic data, such as, for example, web site activity or the speed of an http transaction, although it will be understood that the invention is not limited in scope in this respect. In the present embodiment, the amount and type of data collected may be determined by a user prior to the actual collection of data. The user may select a general type of data that is to be collected, such as, for example, collecting loading times of various web pages. The user may select with specificity what data is to be collected, such as, to provide another example, the number of “hits” on a specific web page. Additionally, the user may select the quantity of data to collect, such as total number of data points, size of the data as measured in bytes, for example, or a certain time period when data is to be collected. It will of course be understood that the invention is not limited in scope in this respect. The criteria for data collection may be determined by a user, wherein the user may set specific values, upper and/or lower bounds may be set, a window of time to collect data may be set, again, providing several possible examples. Of course it will be understood that the invention is not limited in scope in this respect.

In one embodiment, the data collected is stored on a resident system. In this context, a resident system comprises a computing system that is used by a user or system administrator when accessing collected data. The data collected may be stored on the local memory of a resident system, or it may be stored at a location remote from the resident system. In one embodiment, the external source for the data is coupled to the system which collects and stores the collected electronic data. In this embodiment, the external source may be coupled by a network, which may comprise a LAN, WAN, or any other type of suitable network. Of course, it will be understood that the invention is not limited in scope in this respect. For example, an external source may not be coupled to the system that collects the data at all times, but may be coupled only occasionally, or at preset times, for example.

In accordance with one embodiment of the invention, a method of compiling electronic data may further comprise inserting at least a portion of the collected data into one or more data fields, where the data fields, in combination, form an electronic scoreboard of data. In this context, a data field may contain data that is interrelated either by type of value, time of collection, or other factors, but the invention is not limited in this respect. The data in the data fields may be stored on the resident computing platform, or multiple computing platforms that perform the data collection, or on a system external to this computing platform, but the invention is not limited in this respect. In this context, therefore, a scoreboard comprises a set of one or more data fields that that contain electronic data, that may or may not be stored together as a group. In this context, a method of updating a scoreboard may include inserting data that is collected from one or more external sources into a data field that relates at least in part to the particular data collected in the data field. The updating in this context may occur at regular intervals, or may occur upon receipt of additional data, but the invention is not limited in scope in this respect. In this embodiment, the updating of the scoreboard may include deleting the oldest data value in the data field, or it may be a matter of adding new or additional data. In this embodiment, compiling electronic data may further comprise the ability to calculate or measure a statistically based value using at least a portion of the collected electronic data. In this embodiment, calculating statistical values of the electronic data in the data fields may include performing a calculation with the electronic data values that results in one or more numerical representations of the electronic data, where a numerical representation may comprise any representative measurement, including any statistically based value that summarizes the data or some portion thereof. In this embodiment, a statistical value or measure may include but is not limited to the median, mean and/or standard deviation of a set or subset of data values. Such representative measurements or values may be updated periodically based on time, or may be updated based upon receipt of additional data, but the invention is not limited in this respect. Such statistical values, for example, may be determined by the resident system, or they may be determined by a system remote from the resident system, but the invention is not limited in this respect. In accordance with one embodiment of the invention, any value that is representative of a larger set of data values may be used as the measure or statistically based value, but again, the invention is not limited in this respect.

In accordance with this embodiment of the invention, a score may be assigned to the electronic data in one or more data fields, where the data fields contain a collection of electronic data that is interrelated, as previously described. In this embodiment, a score is a value that represents the importance of a set of electronic data, where a set of electronic data is at least a portion of collected electronic data. A score, in this embodiment, is determined automatically, and is a value that is based at least in part on how the data has changed over a particular period of time, although the invention is not limited in this respect. In this embodiment, the score is determined when additional data is inserted into the associated data field. The score may be a calculation of standard deviation, or other statistical value, but the invention is not limited in this respect. In this embodiment, when the score exceeds a value that is determined either by a user or automatically, a report is generated, wherein the report is at least a portion of the electronic data in a data field associated with the score. It will, of course, be understood that this is one possible embodiment, and the invention is not limited in this respect.

In accordance with one embodiment of the invention, reporting electronic data may include retrieving at least a portion of electronic data stored by the data compiler, comparing the electronic data to a threshold value, and reporting at least a portion of the electronic data based at least in part on the comparison to the threshold value. In this context, reports may comprise documents capable of being comprehended by a person or human being either alone or with the aid of a device, and intending to convey information derived from a mass of collected or raw data. The data that is retrieved may be all or a portion of the collected or compiled data that is collected from one or more external sources and inserted into one or more data fields. The type and amount of data that is retrieved may depend, at least in part, upon the threshold value, how many data points or samples have been collected, however, the invention is not limited in this respect. The data may then be compared to a threshold value, and in this context, a threshold value ay comprise a numerical value that will allow for a determination of whether or not the data should be reported. In this embodiment, as previously described, the determination of whether or not data should be reported may be a comparison of a threshold value to a statistical value or measure of collected data. In this embodiment, the threshold value may be determined automatically, depending at least partially on the amount and/or quality of the collected data, or it may be determined by a user, based at least in part on the importance or relevancy of the data, for example. In this embodiment, the electronic report format may be predetermined, such as, by software, or determined by a user, depending on the specific desires of the user. In this context, configurable refers to the ability of the threshold value to be changed, and in accordance with one embodiment, the threshold value may be changed by a user or automatically by software, but the invention is not limited in this respect. In one embodiment, a user may have the ability to “fine tune” the report frequency, such as, for example, by adjusting the threshold value higher or lower in order to modify the frequency of reports. In an alternative embodiment, this fine-tuning may be performed by a software program, for example, or increase the number of reports issued, or any number of other possible reasons. Frequency of reporting may be based at least in part on a lapse of time, on the collection and summarizing of a certain number of values, or on the receipt of a particular threshold value in a particular data field. Of course, the invention is not limited in scope in this respect.

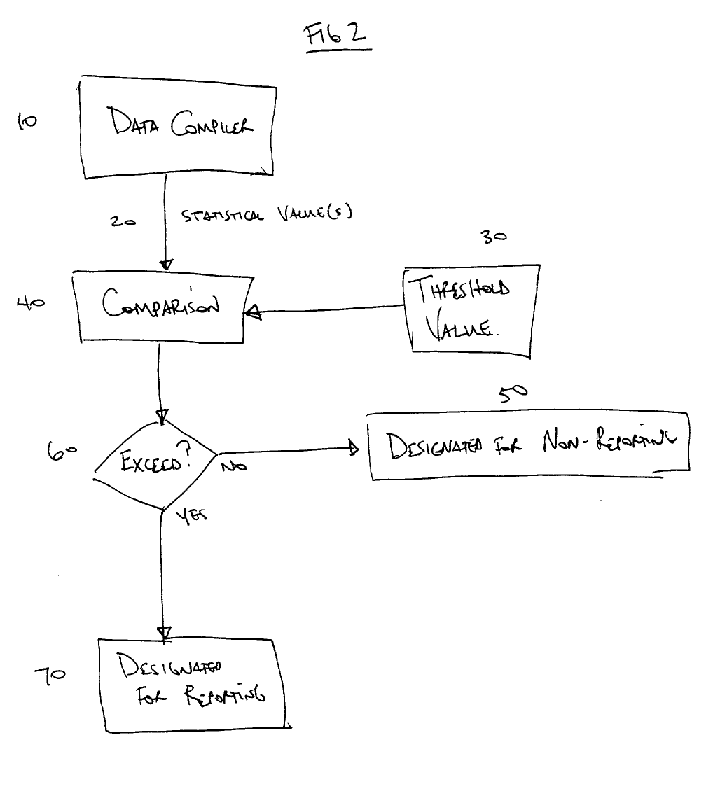

FIG. 2 depicts an embodiment of a method for generation of electronic reports in accordance with the present invention. Block 10 depicts operation of the data compiler, which is also represented substantially in FIG. 1. Therefore, at block 10, a statistical value or values is computed and then transmitted, represented by arrow 20, to a comparison function, represented by block 40. Block 40 also receives a threshold value for comparison. The threshold value may comprise a value that relates at least in part to the statistical value or values sent by the data compiler. This threshold value may be determined by a software program as a preexisting value, or it may be determined through a user interface, providing the ability to make it configurable. At block 40, the values are compared, and a determination is made at block 60 as to whether or not the statistical value exceeds the threshold value, in this particular embodiment. Should it be determined that the statistical value does exceed the threshold value, then block 70 represents an operation that designates the related data as being approved for reporting. If the threshold value is not exceeded, then block 50 represents an operation that designates the related data as being not approved for reporting. In another alternative embodiment, the threshold value and the statistical value or values are compared, and a determination is made as to whether the statistical value or values are less than the threshold value, and if the statistical value does not exceed the threshold value, then block 70 represents an operation that designates the related data as being approved for reporting. If the threshold value is exceeded, then block 50 represents an operation that designates the related data as being not approved for reporting, in this alternative embodiment. A user is free to override this designation, as they desire, in this embodiment. Likewise, in accordance with one embodiment of the invention, displaying online data may include receiving data from one or more external sources, and displaying at least a portion of the data in a format that would allow a person or human being to comprehend the data. The data may be reported in its entirety or may be summarized, and may be displayed on a screen or other peripheral device.

Embodiments of the present invention may be implemented in hardware or software, or a combination of both. However, embodiments of the invention may be implemented as computer programs executing on programmable systems comprising at least one processor, a data storage system, which includes volatile and non-volatile memory and/or storage elements, at least one input device, and at least one output device. Program code may be applied to input data to perform the functions described herein and generate output information. The output information may be applied to one or more output devices, in known fashion. For purposes of this application, a processing system embodying the task management components and network topology components includes any system that has a processor, such as, for example, a digital signal processor (DSP), a microcontroller, an application specific integrated circuit (ASIC), or a microprocessor.

The programs may be implemented in a high level procedural or object oriented programming language to communicate with the processing system. The programs may also be implemented in assembly or machine language, if desired. In fact, the invention is not limited in scope to any particular programming language.

The programs may be stored on a removable storage media or device, such as, for example, floppy disk drive, read only memory (ROM), CD-ROM device, flash memory device, digital versatile disk (DVD), or other storage device, readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

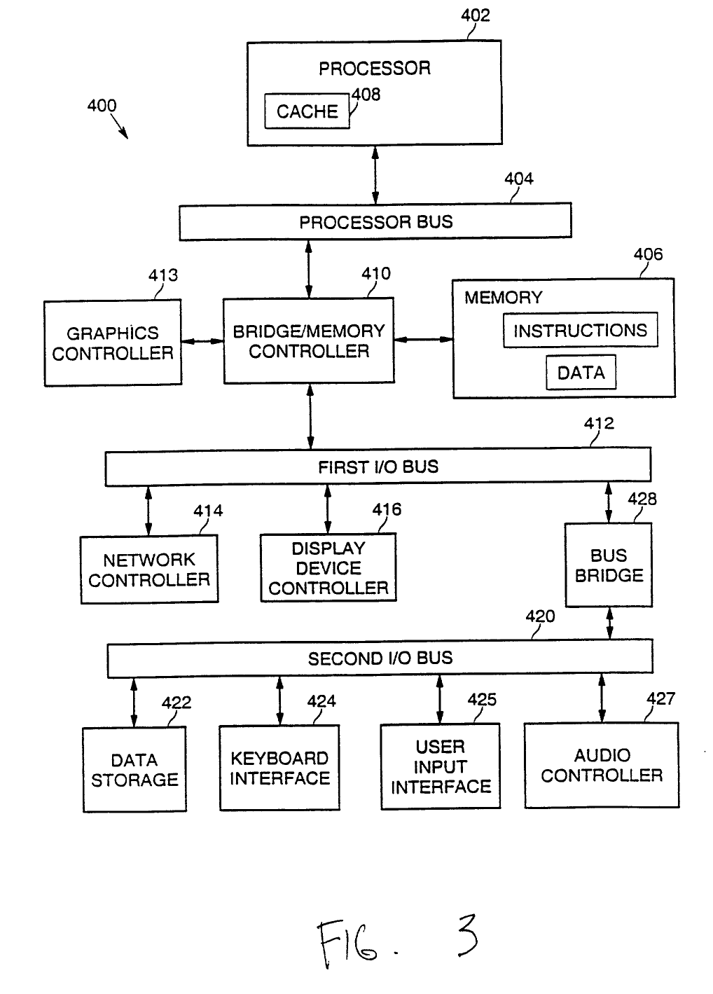

An example of one such type of processing system is shown in FIG. 3, however, other systems may also be used and not all components of the system shown are required for the present invention. Sample system 400 may be used, for example, to execute the processing for embodiments of the system for generating electronic reports, in accordance with the present invention, such as the embodiment described herein. Sample system 400 is representative of processing systems based on the PENTIUM®, PENTIUM®, and CELERON™ microprocessors available from Intel Corporation, although other systems (including personal computers (PCs) having other microprocessors, engineering workstations, other set-top boxes, and the like) and architectures may also be used.

FIG. 4 is a block diagram of a system 400 of one embodiment of the present invention. The system 400 includes a processor 402 that processes data signals. Processor 402 may be coupled to a processor bus 404 that transmits data signals between processor 402 and other components in the system 400.

System 400 includes a memory 406. Memory 406 may store instructions and/or data represented by data signals that may be executed by processor 402. The instructions and/or data may comprise code for performing any and/or all of the techniques of the present invention. Memory 406 may also contain additional software and/or data (not shown). A cache memory 408 may reside inside processor 402 that stores data signals stored in memory 406.

A bridge/memory controller 410 may be coupled to the processor bus 404 and memory 406. The bridge/memory controller 410 directs data signals between processor 402, memory 406, and other components in the system 400 and bridges the data signals between processor bus 404, memory 406, and a first input/output (I/O) bus 412. In this embodiment, graphics controller 413 interfaces to a display device (not shown) for displaying images rendered or otherwise processed by the graphics controller 413 to a user.

First I/O bus 412 may comprise a single bus or a combination of multiple buses. First I/O bus 412 provides communication links between components in system 400. A network controller 414 may be coupled to the first I/O bus 412. In some embodiments, a display device controller 416 may be coupled to the first I/O bus 412. The display device controller 416 allows coupling of a display device to system 400 and acts as an interface between a display device (not shown) and the system. The display device receives data signals from processor 402 through display device controller 416 and displays information contained in the data signals to a user of system 400.

A second I/O bus 420 may comprise a single bus or a combination of multiple buses. The second I/O bus 420 provides communication links between components in system 400. A data storage device 422 may be coupled to the second I/O bus 420. A keyboard interface 424 may be coupled to the second I/O bus 420. A user input interface 425 may be coupled to the second I/O bus 420. The user input interface may be coupled to a user input device, such as a remote control, mouse, joystick, or trackball, for example, to provide input data to the computer system. An audio controller 427 may be coupled to the second I/O bus for handling processing of audio signals through one or more loudspeakers (not shown). A bus bridge 428 couples first I/O bridge 412 to second I/O bridge 420.

Embodiments of the present invention are related to the use of the system 400 as a system for generating electronic reports. According to one embodiment, such processing may be performed by the system 400 in response to processor 402 executing sequences of instructions in memory 404. Such instructions may be read into memory 404 from another computer-readable medium, such as data storage device 422, or from another source via the network controller 414, for example. Execution of the sequences of instructions causes processor 402 to execute a system for generating electronic reports according to embodiments of the present invention. In an alternative embodiment, hardware circuitry may be used in place of or in combination with software instructions to implement embodiments of the present invention. Thus, the present invention is not limited to any specific combination of hardware circuitry and software.

The elements of system 400 perform their conventional functions in a manner well known in the art. In particular, data storage device 422 may be used to provide long-term storage for the executable instructions and data structures for embodiments of the system for generating electronic reports in accordance with the present invention, whereas memory 406 is used to store on a shorter term basis the executable instructions of embodiments of the network management system in accordance with the present invention during execution by processor 402.

While certain features of the invention have been illustrated as described herein, many modifications, substitutions, changes, and equivalents will now occur to those skilled in the art. It is, therefore, to be understood that the appended claims are intended to cover all such embodiments and changes as fall within the true spirit of the invention.

What is claimed is:

1. A method of compiling electronic data comprising:
(a) receiving electronic data on a computing platform from at least one external source;
(b) inserting at least a portion of the collected data into one or more data fields, wherein said one or more data fields comprise an electronic scoreboard of interrelated data;
(c) updating said electronic scoreboard of data; and
(d) calculating at least one measurement of updated scoreboard data.

2. The method of claim 1, wherein said at least one external source comprises a remote computing platform coupled by a network to the computing platform that receives the electronic data.

3. The method of claim 2, wherein said at least one external source further comprises data collection software executing on said remote computing platform.

4. The method of claim 1, wherein updating said electronic scoreboard of data comprises removing at least a portion of collected electronic data after a particular amount of time has elapsed.

5. The method of claim 1, wherein updating said electronic scoreboard of data comprises removing at least a portion of collected electronic data after a particular amount of data is collected.

6. The method of claim 1, wherein said one or more data fields contain one or more periodically updated lists of related electronic data values.

7. A method of reporting electronic data, said method comprising:
(a) retrieving at least a portion of one or more measurement values;
(b) comparing a least a portion of one or more measurement values to one or more threshold values;
(c) determining whether to designate at least a portion of the electronic data related to the one or more measurement values for reporting, based at least in part on the comparison;
and
(d) sending at least the portion of the electronic data designated for reporting to a remote device.

8. The method of claim 7, wherein the one or more measurement values comprise statistical values obtained from a sample of the electronic data.

9. The method of claim 8, wherein said one or more threshold values comprise one or more numerical values that relate at least in part to said statistical values.

10. The method of claim 7, wherein the electronic data comprises text data.

11. The method of claim 7, wherein comparing comprises:
comparing the one or more threshold values to the one or more measurement values, and
issuing at least one electronic report if the one or more measurement values exceeds the one or more threshold values.

12. The method of claim 7, wherein the one or more threshold values are configurable.

13. The method of claim 12, wherein the configuration is determined by a user.

14. The method of claim 7, wherein the remote device comprises a computing platform capable of receiving electronic data.

15. A method of generating electronic reports, said method comprising:
(a) collecting electronic data from at least one external source;
(b) inserting the collection of electronic data into a plurality of associated data fields;
(c) assigning scores to at least a portion of the data contained in the plurality of data fields;
(d) issuing electronic reports based at least in part on said scores.

16. the method of claim 15, wherein steps (b), (c) and (d) are repeated based at least in part on additional collected electronic data.

17. A method of data reduction comprising:
receiving interrelated electronic data regarding electronic transactions occurring via at least one selected web site;
compiling said interrelated data into a plurality of data fields, said data fields arranged to provide sample statistics of said interrelated data;
updating said interrelated electronic data fields with additional data regarding more recent electronic transactions occurring via said at least one selected web site, wherein said updating updates said sample statistics;
after at least one update, comparing said updated sample statistics with at least one preset threshold value; and
generating at least one report based at least in part on the comparison.

18. The method of claim 17, wherein said sample statistics comprise at least the mean and standard deviation.

19. The method of claim 17, wherein said threshold value is configurable.

20. The method of claim 17, and further comprising:
updating said one or more data fields by omitting at least a portion of the collected electronic data other than said additional data.

21. A method of displaying electronic data, said method comprising:
(a) receiving at least a portion of electronic data reports from at least one external source, wherein the electronic data reports comprise electronic data collected and compiled, and reported based at least in part on a priority system; and
(b) displaying at least a portion of the electronic data reports as a computer output.

22. The method of claim 21, wherein said electronic data reports comprise data at least partially relating to online or internet activity.

23. The method of claim 21, wherein said priority system comprises comparing one or more threshold values to one or more statistical or representative values of at least a portion of the collected electronic data.

24. An article comprising:
a storage medium having stored thereon instructions, that when executed by a computing platform, result in execution of an electronic report generator, by:
collecting electronic data from at least one external source;
compiling said collected electronic data; and
reporting said compiled electronic data based at least in part on a priority basis.

25. The article of claim 24, wherein said medium further has stored thereon instructions that, when executed, result in said electronic data being compiled by inserting at least a portion of said collected electronic data into one or more data fields.

26. The article of claim 24, wherein said medium further has stored thereon instructions that, when executed, result in determining one or more measurement values of said electronic data, wherein said measurement values comprise one or more representative values of at least a portion of said collected electronic data.

27. The article of claim 24, wherein said medium further has stored instructions that, when executed, result in determining priority based at least in part on the comparison of said one or more measurement values to one or more threshold values, wherein said one or more threshold values comprises one or more numerical values that relate at least in part to said one or more measurement values.

28. A system for generation of electronic reports comprising:
a computing platform;
said computing platform being adapted to, in operation, perform the generation of electronic reports by:
collecting electronic data from at least one external source;
compiling said collected electronic data; and
reporting said compiled electronic data based at least in part on a priority basis.

29. The system of claim 28, wherein compiling said collected electronic data further comprises inserting at least a portion of said collected electronic data into one or more data fields.

30. The system of claim 28, wherein compiling said collected electronic data further comprises determining one or more measurement values of said collected electronic data, wherein said one or more measurement values comprise one or more representative values of at least a portion of said collected electronic data.

31. The system of claim 28, wherein said priority basis is determined based at least in part on a comparison of said one or more measurement values to said one or more threshold values, wherein said one or more threshold values comprise one or more numerical values that relate at least in part to said one or more measurement values.
